(19) United States
(12) Patent Application Publication
(10) Pub. No.: US 2025/0296197 A1
(43) Pub. Date: Sep. 25, 2025

(54) GRINDING SYSTEM AND METHOD FOR CONTROLLING GRINDING SYSTEM

(71) Applicant: HONDA MOTOR CO., LTD., TOKYO (JP)

(72) Inventors: Naoki IWASA, MINATO-KU, TOKYO (JP); Daisuke YOSHIDA, MINATO-KU, TOKYO (JP); Tetsuya SHINOHARA, MINATO-KU, TOKYO (JP); Junichi NISHIYAMA, MINATO-KU, TOKYO (JP)

(21) Appl. No.: 19/062,814

(22) Filed: Feb. 25, 2025

(30) Foreign Application Priority Data
Mar. 21, 2024 (JP) 2024-044404

(51) Int. Cl. B24B 51/00; B23F 1/02

(52) U.S. Cl. CPC B24B 51/00; B23F 1/02

(57) ABSTRACT

A grinding system includes a signal acquisition unit configured to acquire a first signal and a second signal, a synchronization signal generation unit configured to generate, based on the first signal and the second signal, a synchronization signal for synchronously rotating a first rotating body with respect to a second rotating body, a command signal generation unit configured to generate a command signal based on the synchronization signal and a pre-determined canceling signal for suppressing the fluctuation of the rotational speed of the first rotating body caused by the cogging of a motor that rotates the first rotating body, and a signal output unit configured to output the command signal generated by the command signal generation unit and control the motor.

### CROSS-REFERENCE TO RELATED APPLICATIONS

This application is based upon and claims the benefit of priority from Japanese Patent Application No. 2024-044404 filed on Mar. 21, 2024, the contents of which are incorporated herein by reference.

### BACKGROUND OF THE INVENTION

### Field of the Invention

The present disclosure relates to a grinding system and a method for controlling the grinding system.

### Description of the Related Art

JP 5467833 B2 discloses a grinding system in which a gear-shaped workpiece and a grinding tool are meshed and rotated to grind a workpiece tooth surface of the workpiece with a helical grinding tooth surface of the grinding tool.

### SUMMARY OF THE INVENTION

Better grinding systems and methods for controlling the grinding systems are long-awaited.

The present disclosure aims to solve the aforementioned problems.

A first aspect of the present disclosure is a grinding system wherein a gear-shaped workpiece and a grinding tool are meshed and rotated, whereby a workpiece tooth surface of the workpiece is ground with a helical grinding tooth surface of the grinding tool, one of the workpiece or the grinding tool is a first rotating body, another one of the workpiece or the grinding tool is a second rotating body, the grinding system comprising a signal acquisition unit configured to acquire a first signal indicating a rotational speed of the first rotating body and a second signal indicating a rotational speed of the second rotating body, a synchronization signal generation unit configured to generate, based on the first signal and the second signal, a synchronization signal for synchronously rotating the first rotating body with respect to the second rotating body, a command signal generation unit configured to generate a command signal based on the synchronization signal and a predetermined canceling signal for suppressing fluctuation in the rotational speed of the first rotating body caused by cogging of a motor that rotates the first rotating body; and a signal output unit configured to output the command signal generated by the command signal generation unit and control the motor.

A second aspect of the present disclosure is a method for controlling a grinding system wherein a gear-shaped workpiece and a grinding tool are meshed and rotated, whereby a workpiece tooth surface of the workpiece is ground with the helical grinding tooth surface of the grinding tool, one of the workpiece or the grinding tool is a first rotating body, and another of the workpiece or the grinding tool is a second rotating body, the method comprising: a signal acquisition step of acquiring a first signal indicating a rotational speed of the first rotating body and a second signal indicating a rotational speed of the second rotating body; a synchronization signal generation step of generating, based on the first signal and the second signal, a synchronization signal for synchronously rotating the first rotating body with respect to the second rotating body; a command signal generation step of generating a command signal based on the synchronization signal and a predetermined canceling signal for suppressing fluctuation in the rotational speed of the first rotating body caused by cogging of a motor that rotates the first rotating body; and a signal output step of outputting the command signal generated in the command signal generation step and control the motor.

According to the present disclosure, a better grinding system and method for controlling the grinding system is provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a grinding system according to an embodiment;

FIG. 2 is a control block diagram for the grinding system;

FIG. 3 is a flowchart showing one example of a method for controlling the grinding system;

FIG. 4 is a flowchart illustrating a canceling signal determination step; and

FIG. 5 is a flowchart illustrating a grinding step.

### DETAILED DESCRIPTION OF THE INVENTION

In recent years, efforts to realize a low-carbon or decarbonized society have become active, and research and development on electric vehicles (hybrid vehicles, fuel cell vehicles, etc.) has been conducted to reduce CO₂ emissions and improve energy efficiency. Such electric vehicles generate less noise when the vehicle is driven compared to conventional general gasoline fueled vehicles. Therefore, electric vehicles are required to reduce the noise generated during the rotation of gears more than gasoline fueled vehicles. In a grinding system, the rotational speed of a workpiece fluctuates because of cogging experienced by the motor that rotates the workpiece. Specifically, the rotational speed of the workpiece fluctuates the number of times corresponding to the number of pairs of the N pole and the S pole of the motor per one rotation of the workpiece. When the rotational speed of the workpiece fluctuates in this way, there is a possibility that a workpiece tooth surface cannot be ground with good accuracy. A grinding error on the workpiece tooth surface caused by motor cogging may cause the generation of abnormal noises when a product gear obtained by grinding the workpiece tooth surface is used. The present disclosure may provide a grinding system and a method for controlling the grinding system that can reduce grinding errors on a workpiece tooth surface caused by motor cogging.

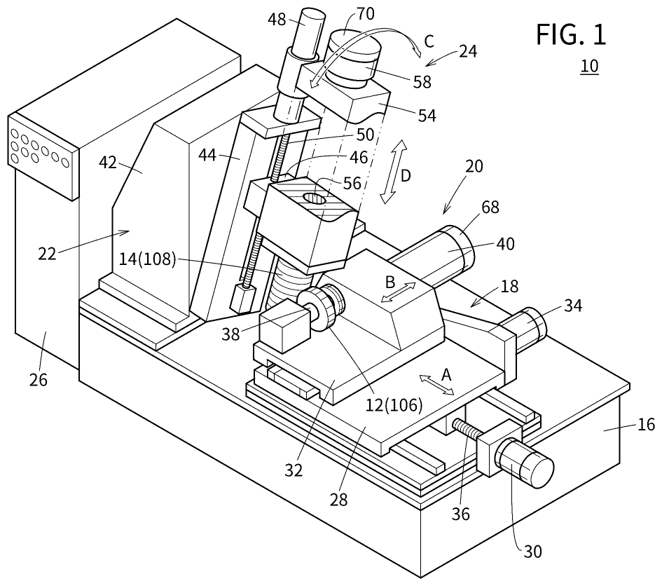

FIG. 1 is a perspective view of a grinding system 10 according to an embodiment. As shown in FIG. 1, the grinding system 10 is a system for grinding a gear-shaped workpiece 12 with a grinding tool 14. The grinding system 10 includes a bed 16, a gear support mechanism 18, a gear rotation mechanism 20, a tool support mechanism 22, a tool rotation mechanism 24, and a controller 26.

The bed 16 is placed, for example, on a horizontal surface of a factory or the like. The gear support mechanism 18 is disposed on a flat upper surface of the bed 16. The gear support mechanism 18 includes a cutting table 28, a cutting motor 30, a traverse table 32, and a traverse motor 34.

The cutting table 28 moves in the A direction with respect to the bed 16. The A direction is a horizontal direction perpendicular to the height direction of the bed 16. The cutting table 28 is connected to the cutting motor 30 via a ball screw shaft 36. The cutting motor 30 moves the cutting table 28 in the A direction by rotating the ball screw shaft 36.

The traverse table 32 is disposed on the upper surface of the cutting table 28. The traverse table 32 moves in the B direction with respect to the cutting table 28. The B direction is a direction perpendicular to the height direction of the bed 16 and the A direction. The traverse table 32 is coupled to the traverse motor 34 via a ball screw shaft (not shown). The traverse motor 34 moves the traverse table 32 in the B direction by rotating the ball screw shaft.

The gear rotation mechanism 20 is arranged on an upper surface of the traverse table 32. The gear rotation mechanism 20 has a gear mounting shaft 38 and a first motor 40. The gear mounting shaft 38 extends in the B direction. The workpiece 12 is attachable to and detachable from the gear mounting shaft 38. The first motor 40 rotates the gear mounting shaft 38.

The tool support mechanism 22 includes a column 42, a pivot table 44, a shift table 46, and a shift motor 48. The column 42 is positioned on the upper surface of the bed 16 so as to face the gear support mechanism 18. The column 42 extends upward from the bed 16. The pivot table 44 is attached to a surface of the column 42 facing the gear support mechanism 18.

The pivot table 44 extends in one direction. A turning motor (not shown) turns the pivot table 44 in the C direction with respect to the column 42. The shift table 46 is provided on a surface of the pivot table 44 facing the gear support mechanism 18. The shift table 46 is coupled to the shift motor 48 via a ball screw shaft 50. The shift motor 48 is attached to the pivot table 44. The shift motor 48 moves the shift table 46 in the D direction with respect to the pivot table 44.

The tool rotation mechanism 24 includes a base 54, a tool mounting shaft 56, and a second motor 58. The base 54 is attached to a surface of the shift table 46 facing the gear support mechanism 18. The base 54 extends along the direction in which the pivot table 44 extends. The tool mounting shaft 56 is inserted through the base 54 along the direction in which the base 54 extends. The grinding tool 14 is attachable to and detachable from the tool mounting shaft 56. The second motor 58 rotates the tool mounting shaft 56.

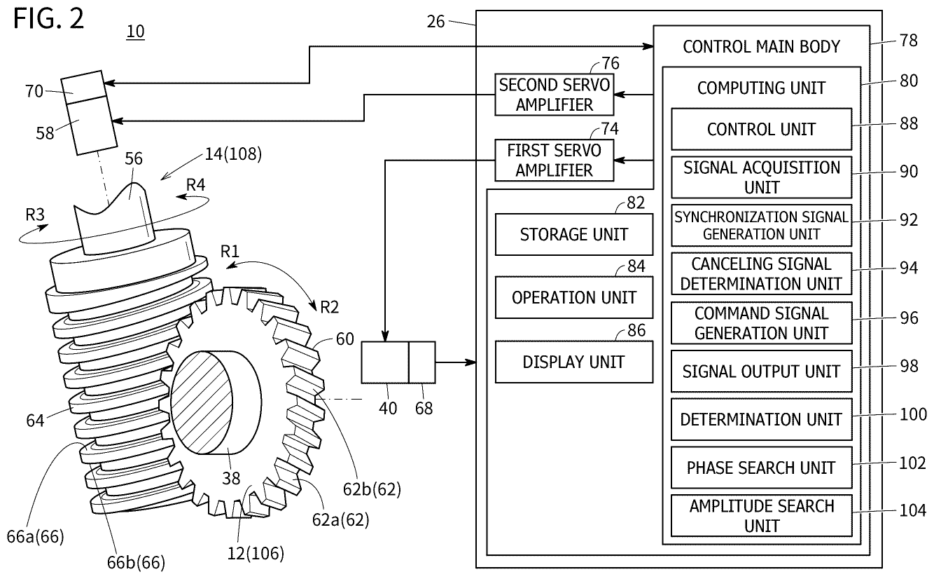

As shown in FIG. 2, the workpiece 12 is mounted on the gear mounting shaft 38. The workpiece 12 can be rotated in the R1 direction and the R2 direction by the driving force of the first motor 40. The workpiece 12 has a plurality of teeth 60. Each of the teeth 60 is formed with a workpiece tooth surface 62. The workpiece tooth surface 62 includes a left workpiece tooth surface 62a and a right workpiece tooth surface 62b.

The grinding tool 14 is mounted on the tool mounting shaft 56. The grinding tool 14 can be rotated in the R3 and R4 directions by the driving force of the second motor 58. The grinding tool 14 is a tool for grinding the workpiece 12. The grinding tool 14 has helical grinding teeth 64. A grinding tooth surface 66 is formed on the grinding tooth 64. The grinding tooth surface 66 includes a first grinding tooth surface 66a and a second grinding tooth surface 66b. For example, single-layer CBN (cubic boron nitride) abrasive grains or the like are electrodeposited on the grinding tooth surface 66 via a nickel plating layer.

When the workpiece 12 is ground by the grinding tool 14, the workpiece 12 and the grinding tool 14 are meshed with each other. With the workpiece 12 and the grinding tool 14 meshed, the left workpiece tooth surface 62a faces the first grinding tooth surface 66a, and the right workpiece tooth surface 62b faces the second grinding tooth surface 66b. With the workpiece 12 and the grinding tool 14 meshed with each other, the workpiece 12 is rotated in the R1 direction and the grinding tool 14 is rotated in the R3 direction, for example, whereby the left workpiece tooth surface 62a can be ground by the first grinding tooth surface 66a and the right workpiece tooth surface 62b can be ground by the second grinding tooth surface 66b. With the workpiece 12 and the grinding tool 14 meshed with each other, the workpiece 12 is rotated in the R2 direction and the grinding tool 14 is rotated in the R4 direction, for example, whereby the left workpiece tooth surface 62a can be ground by the first grinding tooth surface 66a and the right workpiece tooth surface 62b can be ground by the second grinding tooth surface 66b.

The grinding system 10 further includes a first encoder 68 and a second encoder 70. The first motor 40 is provided with the first encoder 68. The first encoder 68 outputs to the controller 26 information (e.g., pulse signals) concerning the rotational phase (rotational speed, rotational angle, rotational position, rotational amount) of the workpiece 12.

The second motor 58 is provided with the second encoder 70. The second encoder 70 outputs to the controller 26 information (e.g., pulse signals) concerning the rotational phase (rotational speed, rotational angle, rotational position, and rotational amount) of the grinding tool 14.

The controller 26 includes a first servo amplifier 74, a second servo amplifier 76, and a control main body 78. The first servo amplifier 74 controls the rotation of the first motor 40 based on command signals output from the control main body 78. The second servo amplifier 76 controls the rotation of the second motor 58 based on command signals output from the control main body 78.

The control main body 78 includes a computing unit 80, a storage unit 82, an operation unit 84, and a display unit 86. The computing unit 80 is composed of a processor such as a CPU (Central Processing Unit) or a GPU (Graphics Processing Unit). That is, the computing unit 80 is formed by processing circuitry.

The computing unit 80 includes a control unit 88, a signal acquisition unit 90, a synchronization signal generation unit 92, a canceling signal determination unit 94, a command signal generation unit 96, a signal output unit 98, a determination unit 100, a phase search unit 102, and an amplitude search unit 104. The control unit 88 controls the cutting motor 30, the traverse motor 34, a turning motor (not shown), and the shift motor 48. The signal acquisition unit 90 acquires a first signal indicating the rotational speed of the workpiece 12 and a second signal indicating the rotational speed of the grinding tool 14. The signal acquisition unit 90 acquires the first signal based on the information output from the first encoder 68. The signal acquisition unit 90 acquires the second signal based on the information output from the second encoder 70.

The synchronization signal generation unit 92 generates, based on the first signal and the second signal, a synchronization signal (work axis speed command signal) for synchronously rotating the workpiece 12 with respect to the grinding tool 14. The synchronization signal is a voltage signal corresponding to the rotational speed of the workpiece 12. The synchronization signal may be a digital signal. The canceling signal determination unit 94 determines a canceling signal for suppressing the fluctuations of the rotational speed of the workpiece 12 caused by the cogging of the first motor 40. The command signal generation unit 96 generates a command signal based on the canceling signal and the synchronization signal. The signal output unit 98 outputs the command signal generated by the command signal generation unit 96 to the first servo amplifier 74 to control the rotation of the first motor 40. The command signal is an analog signal. If the first servo amplifier 74 is compatible with digital signals, the command signal may be a digital signal. The determination unit 100 performs a determination process, which will be described later. The phase search unit 102 searches for an optimal phase of a candidate signal that is a candidate for a canceling signal. The amplitude search unit 104 searches for an optimal amplitude of the candidate signal.

The control unit 88, the signal acquisition unit 90, the synchronization signal generation unit 92, the canceling signal determination unit 94, the command signal generation unit 96, the signal output unit 98, the determination unit 100, the phase search unit 102, and the amplitude search unit 104 can be realized by the computing unit 80 executing programs stored in the storage unit 82. At least a part of the control unit 88, the signal acquisition unit 90, the synchronization signal generation unit 92, the canceling signal determination unit 94, the command signal generation unit 96, the signal output unit 98, the determination unit 100, the phase search unit 102, and the amplitude search unit 104 may be realized by an integrated circuit such as an ASIC (Application Specific Integrated Circuit), an FPGA (Field-Programmable Gate Array), or the like. In addition, at least part of the control unit 88, the signal acquisition unit 90, the synchronization signal generation unit 92, the canceling signal determination unit 94, the command signal generation unit 96, the signal output unit 98, the determination unit 100, the phase search unit 102, and the amplitude search unit 104 may be configured by an electronic circuit including discrete devices.

The storage unit 82 is composed of a volatile memory (not shown) and a nonvolatile memory (not shown). Examples of the volatile memory include, for example, a RAM (Random Access Memory) or the like. The volatile memory is used as working memory of a processor to temporarily store data or the like required for processing or computing operations. Examples of the nonvolatile memory include, for example, a ROM (Read Only Memory), a flash memory, or the like. The non-volatile memory is used as memory for storage, storing programs, tables, maps, etc. At least part of the storage unit 82 may be provided in the above-described processor, integrated circuit, etc.

The operation unit 84 is used when a user operates the controller 26. The operation unit 84 may include a keyboard, a mouse, and the like. The display unit 86 is provided with a display element (not shown). As the display element, for example, a liquid crystal display element, an organic electroluminescence display element, or the like is used. The operation unit 84 and the display unit 86 may be configured by a touch panel (not shown) provided with such a display element.

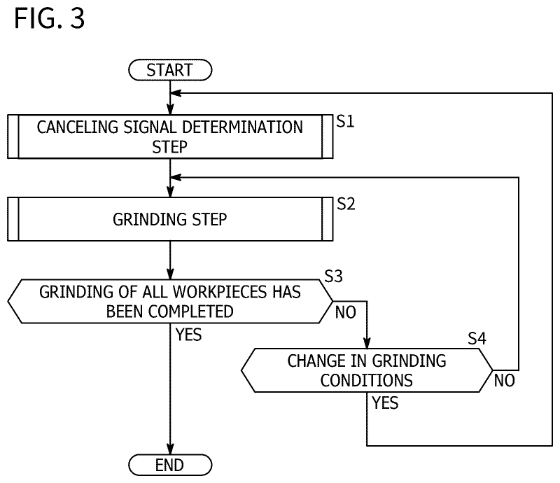

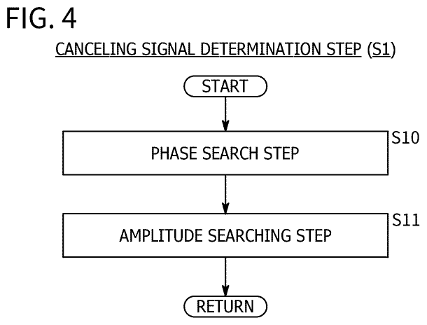

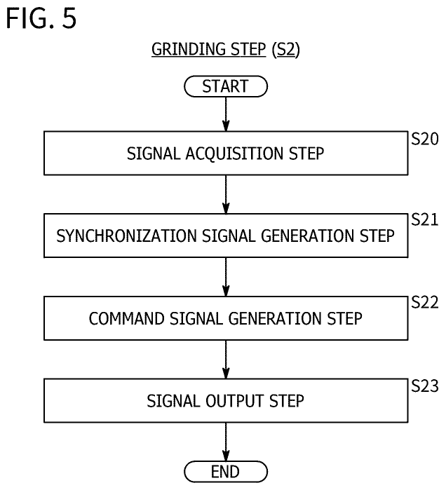

Next, an example of a method for controlling the grinding system 10 will be described. FIG. 3 is a flowchart illustrating an example of a method for controlling the grinding system 10. FIG. 4 is a flowchart illustrating a canceling signal determination step. FIG. 5 is a flowchart illustrating a grinding step. In this embodiment, an example of grinding a plurality of workpieces 12 will be described.

As shown in FIG. 3, in step S1, a canceling signal determination step is performed. In the canceling signal determination step, the workpiece 12 is mounted on the gear mounting shaft 38 and the grinding tool 14 is mounted on the tool mounting shaft 56. Thereafter, in the canceling signal determination step, in a state where the workpiece 12 (first rotating body 106) and the grinding tool 14 (second rotating body 108) are rotating without being meshed with each other, the phase and amplitude of the candidate signal serving as a candidate for canceling a signal are adjusted and the candidate signal that minimizes the amount of fluctuation in the rotational speed of the workpiece 12 caused by the cogging of the first motor 40 (the motor that rotates the first rotating body 106) is determined as the canceling signal.

That is, in the canceling signal determination step, as shown in FIG. 4, a phase search step is performed in step S10. In the phase search step, the phase search unit 102 rotates the workpiece 12 while changing the phase of the candidate signal whereas keeping the amplitude of the candidate signal constant, thereby searching for the optimal phase of the candidate signal that minimizes the amount of fluctuation in the rotational speed of the workpiece 12. The candidate signal is a sinusoidal wave with a frequency corresponding to the frequency of the cogging-induced fluctuation in the rotational speed of the workpiece 12. In other words, the frequency of the candidate signal is identical to the frequency of the cogging-induced fluctuation in the rotational speed of the workpiece 12.

Specifically, in the phase search step, in a state where the workpiece 12 and the grinding tool 14 are rotating without being meshed with each other, the synchronization signal generation unit 92 generates, based on the first signal and the second signal, a synchronization signal for synchronously rotating the workpiece 12 with respect to the grinding tool 14. The canceling signal determination unit 94 generates a candidate signal. Furthermore, the command signal generation unit 96 generates a command signal based on the synchronization signal generated by the synchronization signal generation unit 92 and the candidate signal generated by the canceling signal determination unit 94. The signal output unit 98 outputs the command signal generated by the command signal generation unit 96 to the first servo amplifier 74. The signal acquisition unit 90 acquires a first signal indicating the rotational speed of the workpiece 12 and a second signal indicating the rotational speed of the grinding tool 14.

In the phase seeking step, the amplitude of the candidate signal is kept constant until the phase seeking step is finished. In the phase search step, the phase of the candidate signal is updated (changed) each time the workpiece 12 is rotated by a candidate signal maintaining angle. In other words, in the phase searching step, in a state where the phase of the candidate signal is kept constant, the workpiece 12 is rotated by the candidate signal maintaining angle determined in advance. The candidate signal maintaining angle is determined based on the period of the occurrence of the cogging of the first motor 40. That is, the candidate signal maintaining angle is determined to be the rotation angle of the workpiece 12 at which the cogging of the first motor 40 can occur. The canceling signal determination unit 94 performs frequency analysis (Fourier transform) on data in a range of the rotational speed of the workpiece 12, the range corresponding to the candidate signal maintaining angle, and acquires an amplitude component of the same frequency as the frequency of the cogging of the first motor 40. The amplitude component indicates the fluctuation in the rotational speed of the workpiece 12 caused by the cogging of the first motor 40. In the phase search step, the phase of the candidate signal that minimizes the fluctuation in the rotational speed of the workpiece 12 caused by the cogging of the first motor 40 is determined as the optimal phase. Then, the process transitions to step S11.

In step S11, an amplitude searching step is performed. In the amplitude search step, the amplitude search unit 104 rotates the workpiece 12 while changing the amplitude of the candidate signal whereas keeping the phase of the candidate signal at the optimal signal, thereby searching for the optimal amplitude of the candidate signal that minimizes the amount of fluctuation in the rotational speed of the first motor 40.

Specifically, in the amplitude search step, in a state where the workpiece 12 and the grinding tool 14 are rotating without being meshed with each other, the synchronization signal generation unit 92 generates, based on the first signal and the second signal, a synchronization signal for synchronously rotating the workpiece 12 with respect to the grinding tool 14. The canceling signal determination unit 94 generates a candidate signal. Furthermore, the command signal generation unit 96 generates a command signal based on the synchronization signal generated by the synchronization signal generation unit 92 and the candidate signal generated by the canceling signal determination unit 94. The signal output unit 98 outputs the command signal generated by the command signal generation unit 96 to the first servo amplifier 74. The signal acquisition unit 90 acquires a first signal indicating the rotational speed of the workpiece 12 and a second signal indicating the rotational speed of the grinding tool 14.

In the amplitude searching step, the phase of the candidate signal is kept at the optimal phase found in the search during the phase searching step until the amplitude searching step is finished. In the amplitude search step, the amplitude of the candidate signal is updated (changed) each time the workpiece 12 is rotated by the candidate signal maintaining angle. In other words, in the amplitude searching step, the workpiece 12 is rotated by the candidate signal maintaining angle while the amplitude of the candidate signal is kept constant. The canceling signal determination unit 94 performs frequency analysis (Fourier transform) on data in a range of the rotational speed of the workpiece 12, the range corresponding to the candidate signal maintaining angle, and acquires an amplitude component of the same frequency as the frequency of the cogging of the first motor 40. In the amplitude searching step, the amplitude of the candidate signal that minimizes the fluctuation in the rotational speed of the workpiece 12 caused by the cogging of the first motor 40 is determined as the optimal amplitude. The canceling signal determination unit 94 determines the candidate signal having the optimal phase and the optimal amplitude to be the canceling signal. Thereafter, the process transitions to step S2.

As shown in FIG. 3, in step S2, a grinding step is performed. In the grinding step, the workpiece 12 and the grinding tool 14 are meshed with each other and rotated, whereby the workpiece tooth surface 62 of the workpiece 12 is ground by the grinding tooth surface 66 of the grinding tool 14. In this case, as shown in FIG. 5, in step S20, the workpiece 12 and the grinding tool 14 are meshed with each other.

In step S20, a signal acquisition step is performed. In the signal acquisition step, the signal acquisition unit 90 acquires the first signal indicating the rotational speed of the workpiece 12 and the second signal indicating the rotational speed of the grinding tool 14. Thereafter, the process transitions to step S21.

In step S21, a synchronization signal generation step is performed. In the synchronization signal generation step, the synchronization signal generation unit 92 generates, based on the first signal and the second signal, a synchronization signal for synchronously rotating the workpiece 12 with respect to the grinding tool 14. In other words, the synchronization signal generation unit 92 acquires the phase difference (pulse difference) between the first signal output from the first encoder 68 and the second signal output from the second encoder 70 and generates a synchronization signal so that the phase difference is reduced. Thereafter, the process proceeds to step S22.

In step S22, a command signal generation step is performed. In the command signal generation step, the command signal generation unit 96 generates a command signal based on the synchronization signal and the canceling signal predetermined for suppressing the fluctuation in the rotational speed of the workpiece 12 caused by the cogging of the first motor 40 rotating the workpiece 12. In other words, the command signal generation unit 96 generates the command signal based on the cancelling signal determined in the cancelling signal determination step and the synchronization signal generated in the synchronization signal generation step. Then, the process shifts to step S23.

In step S23, a signal output step is performed. In the signal output step, the signal output unit 98 outputs the command signal generated by the command signal generation unit 96 to control the first motor 40. In other words, the signal output unit 98 outputs the command signal to the first servo amplifier 74. The first servo amplifier 74 controls the rotational speed of the first motor 40 based on the command signal output from the signal output unit 98. In this case, since the command signal is generated based on the synchronization signal and the canceling signal, the fluctuation in the rotational speed due to the cogging of the first motor 40 can be suppressed during the rotation of the workpiece 12.

Thus, the workpiece tooth surface 62 of the workpiece 12 can be accurately ground by the grinding tooth surface 66 of the grinding tool 14. In this embodiment, the workpiece tooth surface 62 is ground over the circumference of the workpiece 12. After the grinding step is completed, the product gear obtained by grinding the workpiece 12 is removed from the gear mounting shaft 38. Thereafter, the process transitions to step S3.

In step S3, the determination unit 100 determines whether grinding of all the workpieces 12 has been completed. When the determination unit 100 determines that grinding of all the workpieces 12 has not been finished (NO in step S3), the determination unit 100 determines whether the grinding conditions have been changed. The grinding conditions herein refer to the size of the workpiece 12, the shape of the workpiece 12, the rotational speed of the workpiece 12 in the grinding step, the size of the grinding tool 14, the shape of the grinding tool 14, the rotational speed of the grinding tool 14 in the grinding step, and the like.

When the determination unit 100 determines that the grinding conditions have not been changed (NO in step S4), the workpiece 12 is mounted on the gear mounting shaft 38, and then the process shifts to step S2. That is, in this case, the canceling signal determination step is not performed. This is because the workpiece 12 can be ground with high accuracy using the cancellation signal already determined if the grinding conditions are not changed.

If the determination unit 100 determines that the grinding conditions have been changed (YES in step S4), for example, a workpiece having a shape different from the workpiece 12 ground last time is mounted on the gear mounting shaft 38. In some cases, the grinding tool 14 may be replaced. Then, the process shifts to step S1. That is, in this case, the canceling signal determination step is performed to determine a new canceling signal corresponding to the current grinding conditions.

When the determination unit 100 determines that grinding of all the workpieces 12 is completed (YES in step S3), the process shown in FIG. 3 ends.

According to the present embodiment, the first motor 40 is controlled by the command signal generated based on the canceling signal and the synchronization signal. Therefore, the fluctuation in the rotational speed of the workpiece 12 caused by the cogging of the first motor 40 during grinding of the workpiece tooth surface 62 can be suppressed. As a result, the grinding error of the workpiece tooth surface 62 can be reduced and thus it is possible to suppress the generation of abnormal noises during the use of the product gear obtained by grinding the workpiece tooth surface 62. Accordingly, a better grinding system 10 and method of controlling the grinding system 10 can be provided.

In the above-described embodiment, the example in which the workpiece 12 is the first rotating body 106 and the grinding tool 14 is the second rotating body 108 has been described. The present disclosure is not limited to such an example, and for example, the grinding tool 14 may be the first rotating body 106 and the workpiece 12 may be the second rotating body 108. In this case, in the canceling signal determination step, in a state where the grinding tool 14 and the workpiece 12 are rotating without being meshed with each other, the canceling signal determination unit 94 adjusts the phase and amplitude of the candidate signal that is a candidate for the canceling signal, and determines, as the canceling signal, the candidate signal that minimizes the amount of fluctuation in the rotational speed of the grinding tool 14 caused by cogging. In the synchronization signal generation step, the synchronization signal generation unit 92 generates, based on the first signal and the second signal, the synchronization signal for synchronously rotating the grinding tool 14 with respect to the workpiece 12. Furthermore, in the command signal generation step, the command signal generation unit 96 generates the command signal based on the synchronization signal and the canceling signal predetermined for suppressing the fluctuation in the rotational speed of the grinding tool 14 caused by the cogging of the second motor 58 rotating the grinding tool 14. In addition, in the signal output step, the signal output unit 98 outputs the command signal generated by the command signal generation unit 96 to control the second motor 58.

With respect to the above embodiments, the following supplementary notes are further disclosed.

### Supplementary Note 1

A grinding system (10) wherein a gear-shaped workpiece (12) and a grinding tool (14) are meshed and rotated, whereby a workpiece tooth surface (62) of the workpiece is ground with a helical grinding tooth surface (66) of the grinding tool, wherein one of the workpiece or the grinding tool is a first rotating body (106) and another of the workpiece or the grinding tool is a second rotating body (108) includes a signal acquisition unit (90) configured to acquire a first signal indicating a rotational speed of the first rotating body and a second signal indicating a rotational speed of the second rotating body, a synchronization signal generation unit (92) configured to generate, based on the first signal and the second signal, a synchronization signal for synchronously rotating the first rotating body with respect to the second rotating body, a command signal generation unit (96) configured to generate a command signal based on the synchronization signal and a predetermined canceling signal for suppressing fluctuation in the rotational speed of the first rotating body caused by the cogging of a motor (40, 58) that rotates the first rotating body, and a signal output unit (98) configured to output the command signal generated by the command signal generation unit and control the motor.

According to such a configuration, the motor for rotating the first rotating body is controlled by the command signal generated based on the canceling signal and the synchronization signal. Therefore, the fluctuation in the rotational speed of the first rotating body caused by the cogging of the motor can be suppressed during the grinding of the workpiece tooth surface. Thus, the grinding error of the workpiece tooth surface can be reduced, and thus the generation of abnormal noises can be suppressed when the product gear obtained by grinding the workpiece tooth surface is used. Therefore, it can provide a better grinding system.

### Supplementary Note 2

The grinding system according to Supplementary note 1 may further include a canceling signal determination unit (94) configured, in a state where the first rotating body and the second rotating body are rotating without being meshed, to adjust a amplitude and a phase of a candidate signal that is a candidate for the canceling signal and to determine, as the canceling signal, the candidate signal that minimizes the amount of fluctuation in the rotational speed of the first rotating body caused by the cogging.

With such a configuration, the canceling signal can be determined easily.

### Supplementary Note 3

In the grinding system according to Supplementary note 2, the candidate signal may be a sinusoidal wave having a frequency corresponding to a frequency of fluctuation in the rotational speed of the first rotating body caused by the cogging.

According to such a configuration, the cogging-induced fluctuation in the rotational speed of the first rotating body can be further reduced.

### Supplementary Note 4

In the grinding system according to Supplementary note 2 or 3, the canceling signal determination unit may include a phase search unit (102) configured to search for the optimal phase of the candidate signal that minimizes the amount of fluctuation by rotating the first rotating body while changing the phase of the candidate signal whereas keeping the amplitude of the candidate signal constant, and an amplitude search unit (104) configured to search for the optimal amplitude of the candidate signal that minimizes the amount of fluctuation by rotating the first rotating body while changing the amplitude of the candidate signal whereas keeping the phase of the candidate signal at the optimal phase.

According to such a configuration, the candidate signal that minimizes the amount of cogging-induced fluctuation in the rotational speed of the first rotating body can be efficiently found.

### Supplementary Note 5

The grinding system according to any one of Supplementary notes 1 to 4, wherein the first rotating body is the workpiece, and the second rotating body may be the grinding tool.

According to such a configuration, the fluctuation in the rotational speed of the workpiece caused by the cogging of the motor for rotating the workpiece can be suppressed.

### Supplementary Note 6

A method for controlling a grinding system, wherein a gear-shaped workpiece and a grinding tool are meshed and rotated, whereby the workpiece tooth surface of the workpiece is ground with the helical grinding tooth surface of the grinding tool, one of the workpiece or the grinding tool is a first rotating body and another of the workpiece or the grinding tool is a second rotating body, includes: a signal acquisition step of acquiring a first signal indicating the rotational speed of the first rotating body and a second signal indicating the rotational speed of the second rotating body; a synchronization signal generation step of generating, based on the first signal and the second signal, a synchronization signal for synchronously rotating the first rotating body with respect to the second rotating body; a command signal generation step of generating a command signal based on the synchronization signal and a predetermined canceling signal for suppressing the fluctuation in the rotational speed of the first rotating body caused by the cogging of a motor that rotates the first rotating body; and a signal output step of outputting the command signal generated in the command signal generation step and controlling the motor.

Such a method can provide a better method for controlling the grinding system because it provides the same benefits as Supplementary note 1.

### Supplementary Note 7

The method for controlling a grinding system according to Supplementary note 6 may further include a canceling signal determination step of, in a state where the first rotating body and the second rotating body are rotating without being meshed with each other, adjusting the amplitude and the phase of a candidate signal that is a candidate for the canceling signal, and determining, as the canceling signal, the candidate signal that minimizes the amount of fluctuation in the rotational speed of the first rotating body caused by the cogging.

According to such a method, the same benefits as Supplementary note 2 are achieved.

### Supplementary Note 8

The method for controlling the grinding system according to Supplementary note 7, wherein the candidate signal may be a sinusoidal wave having a frequency corresponding to the frequency of the fluctuation in the rotational speed of the first rotating body caused by the cogging.

Such a configuration provides the same benefits as Supplementary note 3.

### Supplementary Note 9

The method for controlling a grinding system according to appendix 7 or 8, wherein the canceling signal determination step may include a phase search step for searching for an optimal phase of the candidate signal that minimizes the amount of fluctuation by rotating the first rotating body while changing the phase of the candidate signal whereas keeping the amplitude of the candidate signal constant, and an amplitude search step for searching for an optimal amplitude of the candidate signal that minimizes the amount of fluctuation by rotating the first rotating body while changing the amplitude of the candidate signal whereas keeping the phase of the candidate signal at the optimal phase.

According to such a method, the same benefits as Supplementary note 4 are achieved.

### Supplementary Note 10

The method for controlling a grinding system according to any one of Supplementary notes 6 to 9, wherein the first rotating body may be the workpiece, and the second rotating body may be the grinding tool.

According to such a method, the same benefits as Supplementary note 5 are achieved.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A grinding system wherein a gear-shaped workpiece and a grinding tool are meshed and rotated, whereby a workpiece tooth surface of the workpiece is ground with a helical grinding tooth surface of the grinding tool,
one of the workpiece or the grinding tool is a first rotating body,
another of the workpiece or the grinding tool is a second rotating body,
the grinding system comprising a controller that includes one or more processors executing computer-executable instructions stored in memory,
wherein the one or more processors execute the computer-executable instructions to cause the controller to:
acquire a first signal indicating a rotational speed of the first rotating body and a second signal indicating a rotational speed of the second rotating body;
generate, based on the first signal and the second signal, a synchronization signal for synchronously rotating the first rotating body with respect to the second rotating body;
generate a command signal based on the synchronization signal and a predetermined canceling signal for suppressing fluctuation in the rotational speed of the first rotating body caused by cogging of a motor that rotates the first rotating body; and
output the command signal generated and control the motor.

2. The grinding system according to claim 1, wherein
in a state where the first rotating body and the second rotating body are rotating without being meshed, the controller adjusts a phase and an amplitude of a candidate signal that is a candidate for the cancelling signal, and determines as the cancelling signal the candidate signal that minimizes an amount of fluctuation in the rotational speed of the first rotating body caused by the cogging.

3. The grinding system of claim 2, wherein
the candidate signal is a sinusoidal wave having a frequency corresponding to a frequency of fluctuation in the rotational speed of the first rotating body caused by the cogging.

4. The grinding system according to claim 2, wherein
the controller
rotates the first rotating body while changing the phase of the candidate signal whereas keeping the amplitude of the candidate signal constant, thereby searching for an optimal phase of the candidate signal that minimizes the amount of fluctuation, and
rotates the first rotating body while changing the amplitude of the candidate signal whereas keeping the phase of the candidate signal at the optimal phase, thereby searching for an optimal amplitude of the candidate signal that minimizes the amount of fluctuation.

5. The grinding system according to claim 1, wherein
the first rotating body is the workpiece, and
the second rotating body is the grinding tool.

6. A method for controlling a grinding system wherein a gear-shaped workpiece and a grinding tool are meshed and rotated, whereby a workpiece tooth surface of the workpiece is ground with a helical grinding tooth surface of the grinding tool,
one of the workpiece or the grinding tool is a first rotating body, and
another of the workpiece or the grinding tool is a second rotating body,
the method comprising:
acquiring a first signal indicating a rotational speed of the first rotating body and a second signal indicating a rotational speed of the second rotating body;
generating, based on the first signal and the second signal, a synchronization signal for synchronously rotating the first rotating body with respect to the second rotating body;
generating a command signal based on the synchronization signal and a predetermined canceling signal for suppressing fluctuation in the rotational speed of the first rotating body caused by cogging of a motor that rotates the first rotating body; and
outputting the command signal generated and control the motor.

7. The method for controlling the grinding system according to claim 6, wherein
in a state where the first rotating body and the second rotating body are rotating without being meshed, a phase and an amplitude of a candidate signal that is a candidate for the cancelling signal are adjusted, and the candidate signal that minimizes an amount of fluctuation in the rotational speed of the first rotating body caused by the cogging is determined as the cancelling signal.

8. The method for controlling the grinding system according to claim 7, wherein
the candidate signal is a sinusoidal wave having a frequency corresponding to a frequency of fluctuation in the rotational speed of the first rotating body caused by the cogging.

9. The method for controlling the grinding system according to claim 7, wherein
the first rotating body is rotated while the phase of the candidate signal is changed whereas the amplitude of the candidate signal is kept constant, whereby an optimal phase of the candidate signal that minimizes the amount of fluctuation is searched for, and
the first rotating body is rotated while the amplitude of the candidate signal is changed whereas the phase of the candidate signal is kept at the optimal phase, whereby an optimal amplitude of the candidate signal that minimizes the amount of fluctuation is searched for.

10. The method for controlling the grinding system according to claim 6, wherein
the first rotating body is the workpiece, and
the second rotating body is the grinding tool.
